(19) United States
(12) Patent Application Publication
(10) Pub. No.: US 2018/0306166 A1
(43) Pub. Date: Oct. 25, 2018

(54) CONTINUOUS-FLOW ENERGY INSTALLATION IN PARTICULAR A WIND POWER INSTALLATION

(71) Applicant: FlowGen Development & Management GmbH, Zug (CH)

(72) Inventor: Dirk Karl KÜSTER, Benglen (CH)

(21) Appl. No.: 15/767,755

(22) PCT Filed: Sep. 21, 2016
(86) PCT No.: PCT/EP2016/072426

§ 371 Date: Apr. 12, 2018

(30) Foreign Application Priority Data
Oct. 14, 2015 (EP) 15189785.7

(51) Int. Cl. F03D 1/04

(52) U.S. Cl. CPC F03D 1/04; F03B 3/04

(57) ABSTRACT

The invention relates to a continuous-flow energy installation, in particular a wind power installation, having an at least approximately drop-shaped housing, from the inlet opening of which to the outlet opening the flow channel delimited by the channel wall extends. The propeller is mounted rotatably about the longitudinal axis and fluid flowing through the flow channel, flows axially onto the propeller. The axial position of the propeller can be varied by means of the spacing adjustment drive. Alternatively or additionally the channel wall is variable. The length of the flow channel is, for example, adjustable by means of the length adjustment drive. These variation possibilities make it possible to adapt the energy generation by means of the generator to changed conditions of the fluid stream, in particular the wind.

The present invention relates to a continuous-flow energy installation, in particular a wind power installation, having the features of the preamble of claim 1.

A continuous-flow energy installation of this type is known from document EP2 395 235 A2. It has housing of droplet-shaped cross section which can be adjusted about its perpendicular axis in the flow direction, in particular so as to be aligned with the wind direction. On the front side, the housing has an inlet opening to an inner flow duct which leads to two lateral outlet openings which are arranged on the housing. A propeller with an axial incident flow is arranged in the flow duct, and the flow duct has convexly running boundary faces in its inlet region which adjoins the inlet opening.

Document U.S. Pat. No. 4,178,124 discloses a wind turbine having a frustoconical air inlet opening, at the outlet of which is arranged a turbine unit which is driven rotationally by the air which flows through the air inlet element. The air inlet element has a telescopic inlet extension, in order to improve the turbine performance or in order to increase the air quantity.

Furthermore, document U.S. 2010/0068052 A1 has disclosed a wind turbine with an impeller wheel which is surrounded by a turbine shell housing and/or an ejector shell housing. The turbine shell housing and/or the ejector shell housing have/has inflatable regions or flexible inflatable regions. The turbine shell housing and/or the ejector shell housing can have internal ribs, the shape or length of which can be changed, in order to change the characteristic of the wind turbine.

It is an object of the present invention to provide a continuous-flow energy installation of the generic type which generates energy in an optimum manner in the case of different conditions of the driving fluid.

Said object is achieved by way of a continuous-flow energy installation, in particular a wind power installation, which has the features of claim 1.

The continuous-flow energy installation has a housing with an at least approximately droplet-shaped longitudinal section which defines a longitudinal axis and can be moved in the flow direction of a driving fluid about an axis which runs at least approximately at a right angle with respect to the longitudinal axis. As a result of the droplet-shaped cross section, the housing rotates automatically into the flow direction and the force which acts on the housing from the fluid is minimized.

The housing preferably has an at least approximately planar top wall and an at least approximately planar bottom wall which runs parallel to said top wall, the shape of said wall is preferably corresponding to the at least approximately droplet-shaped longitudinal section. A housing wall runs from the edge of the top wall to the edge of the bottom wall, which housing wall configures a front section upstream, which front section is followed by two side sections which lie opposite one another as far as the downstream end of the housing.

Said shape of the housing with a planar top and bottom wall has the advantage that a plurality of housings can be arranged above one another in a modular manner.

If a plurality of housings and therefore a plurality of continuous-flow energy installations are arranged above one another, the uppermost housing preferably has a rotationally symmetrical top wall with respect to the longitudinal axis, and the lowermost housing preferably has a rotationally symmetrical bottom wall with respect to the relevant longitudinal axis.

If there is only a single housing, it is also conceivable to configure it to be rotationally symmetrical with respect to the longitudinal axis.

The housing has an upstream, front-side inlet opening (in the front section) and an outlet opening which is arranged downstream with regard to said inlet opening. There are preferably two outlet openings which lie opposite one another (in the side sections).

On account of the at least approximate droplet shape of the housing, a vacuum is built up by way of the fluid which flows around said housing, which vacuum exerts a suction effect on the fluid flow which flows in the interior of the housing from the inlet opening to the outlet opening or the outlet openings.

A flow duct for the fluid, which flow duct runs from the inlet opening to the outlet opening or the outlet openings and is delimited by a duct wall, runs in the interior of the housing. There is a propeller in the flow duct, which propeller can be rotated about the longitudinal axis and onto which the fluid which flows through the flow duct can flow axially. Said propeller serves to drive an electric generator. The diameter of the propeller is preferably only slightly smaller than the clear span of the flow duct at the propeller, with the result that as far as possible the entire fluid flow which flows through the flow duct serves to drive the propeller.

The driving fluid can have different velocities and different densities. In order for it to be possible to optimize the power generation in the case of said different fluid conditions, the axial position of the propeller is of adjustable or changeable configuration and/or the duct wall is of adjustable or changeable configuration. There is in each case one drive for said adjustment or change.

The embodiment according to the invention of the continuous-flow energy installation can also serve for increased safety, by only a part of the fluid which flows through the flow duct being utilized to drive the propeller, for example, at very high velocities of the fluid.

The fluid is preferably a gaseous medium, in particular air. A liquid medium, in particular water, is also conceivable, however.

It is also possible that the housing does not taper in a wedge shape or acutely on the downstream side, but rather can be of “truncated” configuration in order to achieve a shorter overall design.

Furthermore, it is to be noted that the duct wall is of rotationally symmetrical configuration at least from the inlet opening as far as downstream of the propeller, preferably with respect to the longitudinal axis which also coincides with the rotational axis of the propeller.

Furthermore, it is to be mentioned that the outlet opening or the outlet openings can extend over the entire height of the housing. In this case, it is conceivable that the top wall and/or the bottom wall can have corresponding recesses, in order to increase the outlet opening or outlet openings.

The duct wall preferably has an inlet section which tapers in the flow direction and is preferably rotationally symmetrical with respect to the longitudinal axis. Said inlet section can be of conical or (in the direction of the longitudinal axis) convex configuration, and preferably directly adjoins the inlet opening.

The inlet section is preferably adjoined continuously by a center section which is rotationally symmetrical with respect to the longitudinal axis and in which there is also the smallest diameter of the flow duct. The cross section of the flow duct is preferably at least approximately constant in the center section. This is also to include a convex embodiment, the curvature being substantially smaller, however, than in the inlet section if the latter is of convex configuration.

The center section is preferably adjoined continuously by an outlet section of the duct wall, which outlet section leads to the outlet opening or the outlet openings. In the outlet section, the duct wall is of widening configuration in the flow direction, with the result that the cross section of the flow duct preferably increases continuously in a diffusion-like manner as far as the outlet opening or the outlet openings.

The propeller is preferably arranged in the center section or in an upstream end region of the outlet section, preferably where there are the highest velocities of the fluid.

In one preferred embodiment, the length of the center section as measured in the direction of the longitudinal axis is of variable configuration. In order to change said length, there is a length adjustment drive.

For this purpose, the duct wall can be joined in two parts in the axial direction in the center section and can be of telescopic configuration. Here, the length adjustment drive preferably acts between the two parts of the duct wall. That part of the center section which is connected to the outlet section, is preferably stationary with regard to the housing, and that part of the center section which is connected to the inlet section is preferably configured so as to be displaceable in the axial direction.

It is also conceivable to configure the duct wall to be elastically extendable in the axial direction in the center section.

In one preferred embodiment, the cross section of the center section is of variable configuration, and there is a cross section adjustment drive for changing the cross section. This possibility can be present together with the variability of the length of the center section.

It is conceivable, for example, to form the center section of the duct wall from center section wall segments which overlap in a scale-like manner and the overlap of which can be changed by means of the cross section adjustment drive, in order to make the cross section of the flow duct smaller or larger.

It is also conceivable to configure the duct wall, in particular in the center section, as a diaphragm, and to change the shape by means of the cross section adjustment drive in such a way that the inside cross section is made larger or smaller.

The inlet section preferably forms an inlet opening by way of its upstream end, and said inlet section is configured in such a way that the inlet opening can be made larger and smaller by means of the inlet adjustment drive.

For this purpose, it is conceivable to configure the inlet opening to be preferably conical and to configure said inlet opening by way of inlet segments which overlap in a scale-like manner in the circumferential direction. As a result, it is made possible to change the cone angle by means of the inlet adjustment drive, the clear span preferably remaining unchanged at the downstream end of the inlet section, that is to say in the case of the center section.

It is conceivable that, in the case of the largest possible inlet opening, said inlet opening coincides with the inlet opening of the housing and, if the inlet opening is made smaller, an annular gap is produced between the housing and the duct wall. Said annular gap can serve, in particular at very high velocities of the fluid, to conduct only a part of the fluid, which flows through the inlet opening into the flow duct. The other part can be fed to the surroundings again, for example by way of associated openings in the housing.

The flow duct in the outlet section is preferably also delimited by way of an inner wall which widens in the flow direction and lies on the inside with regard to the duct wall. Said inner wall can be configured so as to be rotationally symmetrical with respect to the longitudinal axis and so as to widen conically. The shape of the inner wall which widens in a wedge-shaped manner is preferred, however, which inner wall possibly extends from the bottom wall to the top wall. In this case, the flow duct is divided by way of the inner wall into two outflow sections which lead to the lateral outlet openings.

The inner wall can be of deformable configuration; for example, flexible. This makes it possible to adapt the flow cross sections there of the flow duct to different conditions of the fluid. A shape changing drive is provided for changing the shape.

The generator which is operatively connected to the propeller is preferably arranged in the housing downstream of the inner wall. As a result, it is protected against environmental influences and the fluid which flows through the continuous-flow energy installation.

The generator and the propeller are preferably arranged at a fixed spacing from one another and are mounted such that they can be adjusted jointly in the direction of the longitudinal axis with regard to the housing, a position adjustment drive making the change of the axial positions of the generator and the propeller possible. The generator shaft can support the propeller which is mounted fixedly on it, and the generator can be fastened on a slide or a carriage.

It is also possible, however, that the generator is arranged in a stationary manner with regard to the housing. In this case, the propeller is configured such that it can be displaced in the axial direction relative to the generator, it being possible for the position of the propeller to be set by means of the spacing adjustment drive. This can be achieved, for example, by virtue of the fact that the propeller is mounted on the generator shaft fixedly so as to rotate with it, but such that it can be displaced in the axial direction.

The variability of the position of the propeller can be combined with the embodiment with a variable length of the center section and/or with the embodiment with a variable setting section and/or with the embodiment with a variable diameter.

The housing preferably has a single inlet opening and two lateral outlet openings which lie opposite one another. In this case, a single generator is preferably provided which is driven by the propeller. It is to be mentioned in this content that the propeller can also have two or more propeller sets which are arranged behind one another in the longitudinal direction.

The continuous-flow energy installation preferably has a mast, on which the housing is mounted such that it can be pivoted about the axis.

It is also possible to configure the duct wall in a diaphragm-like manner from the inlet opening as far as the outlet opening, and to configure the cross section so as to be adjustable by means of a cross section adjustment drive. In addition to rubber-elastic materials for forming the diaphragm which is rotationally symmetrical with respect to the longitudinal axis, composite materials can also be provided which have sufficiently elastic properties.

It is also to be mentioned for the sake of completeness that the housing can form a wing-like cross section together with the duct wall.

The present invention also relates to a continuous-flow energy installation with a front-side inlet opening which lies upstream and an outlet opening which is arranged downstream with regard to said inlet opening, a flow duct for a driving fluid, which flow duct runs from the inlet opening to the outlet opening and is delimited by a duct wall, and a propeller for driving an electric generator, which propeller is arranged in the flow duct, can be rotated about the longitudinal axis, and onto which the fluid flows axially, the propeller being configured with an adjustable axial position and/or the duct wall being of adjustable configuration (in order to optimize the power generation in the case of different fluid conditions), and that there is a drive for said adjustment.

Here, the continuous-flow energy installation can also be configured as claimed in the dependent claims with the features which relate to the duct wall, the flow duct, the propeller and the generator.

In the case of all the embodiments, the duct wall forms a nozzle on the inlet side and a diffuser on the outlet side.

The continuous-flow energy installation is preferably a wind power installation. The configuration as a hydroelectric power installation is also possible, however.

The invention will be described in greater detail using embodiments which are shown in the drawing, in which, purely diagrammatically:

FIG. 1 shows a perspective illustration from the front and the side of a wind power installation according to the invention with a housing which is droplet-shaped in longitudinal section, a flow duct which runs in said housing, and a propeller for driving an electric generator, which propeller is arranged in the flow duct,

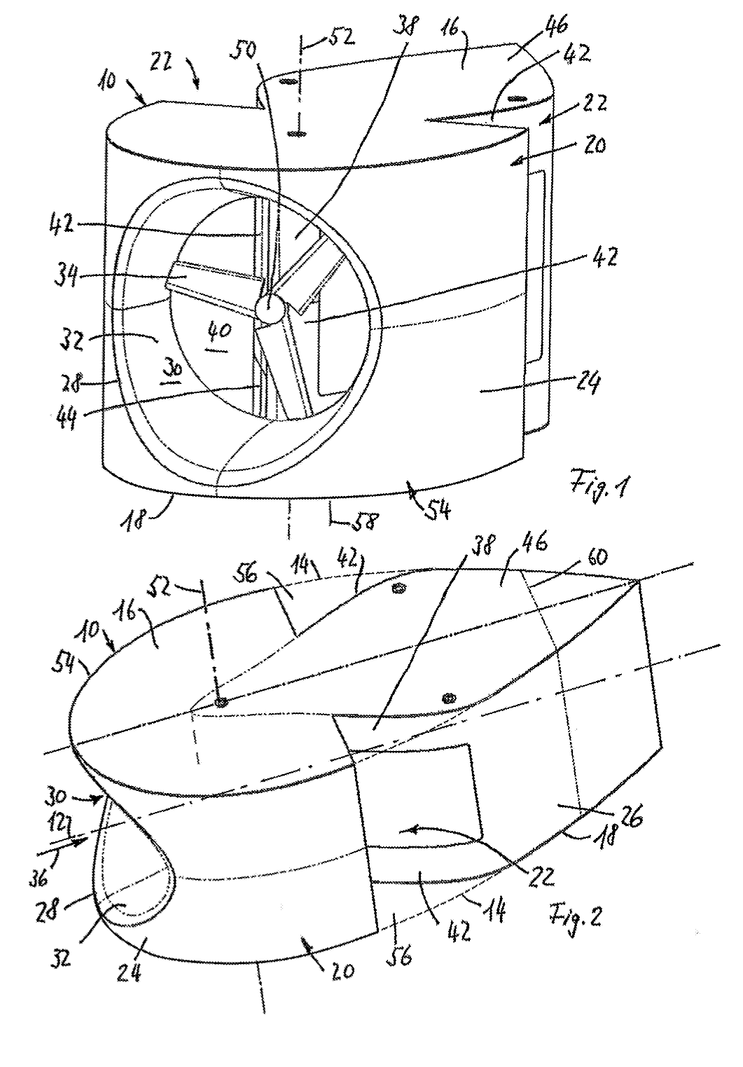

FIG. 2 shows the wind power installation in accordance with FIG. 1 in a perspective illustration from the top and the side,

FIG. 3 shows a longitudinal section of a part of the wind power installation with an unchangeable duct wall which delimits the flow duct, and a propeller with a variable axial position,

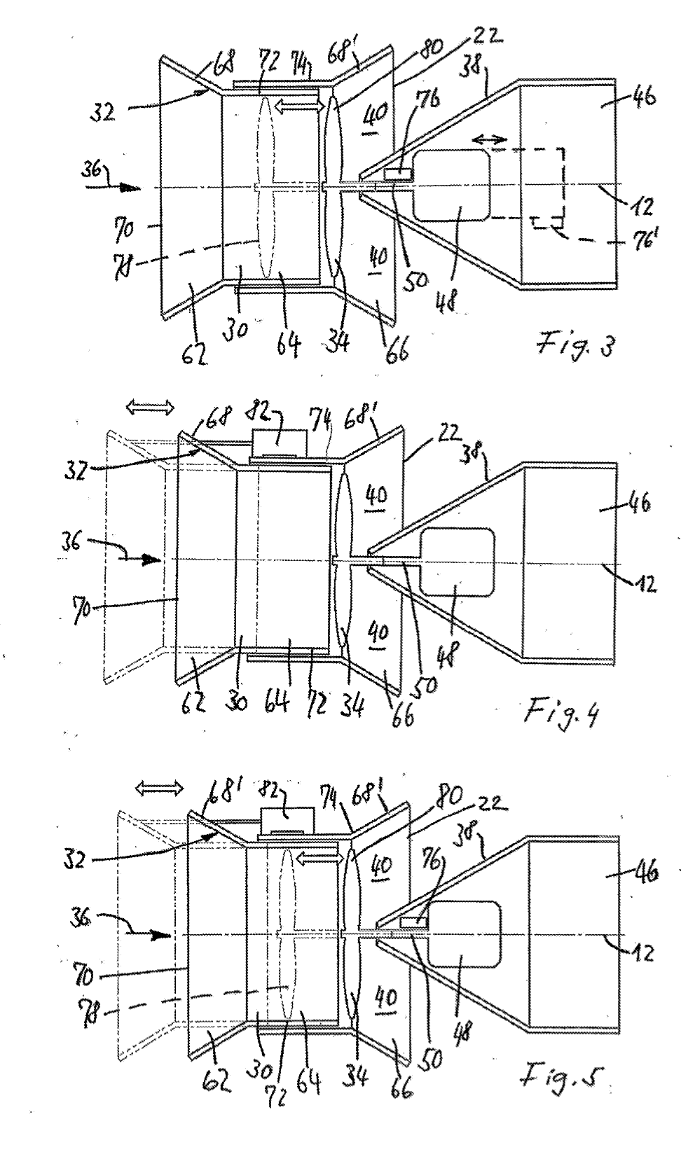

FIG. 4 shows an identical illustration to FIG. 3 of the wind power installation with a duct wall with an adjustable length and a propeller which is arranged fixedly in the axial direction,

FIG. 5 shows an identical illustration to FIGS. 3 and 4 of the wind power installation with a duct wall with an adjustable length and a propeller with an adjustable axial position,

FIG. 6 shows an identical illustration to FIGS. 1 to 5 of the wind power installation, in which an inlet section of the duct wall is configured so as to be conical and with an adjustable cone angle,

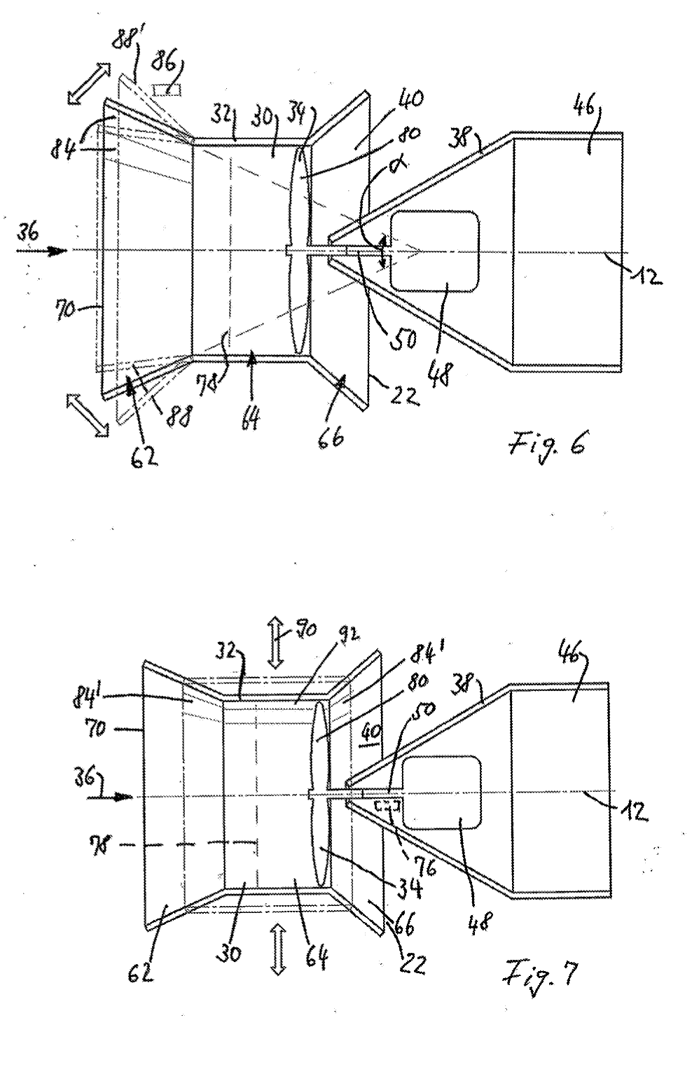

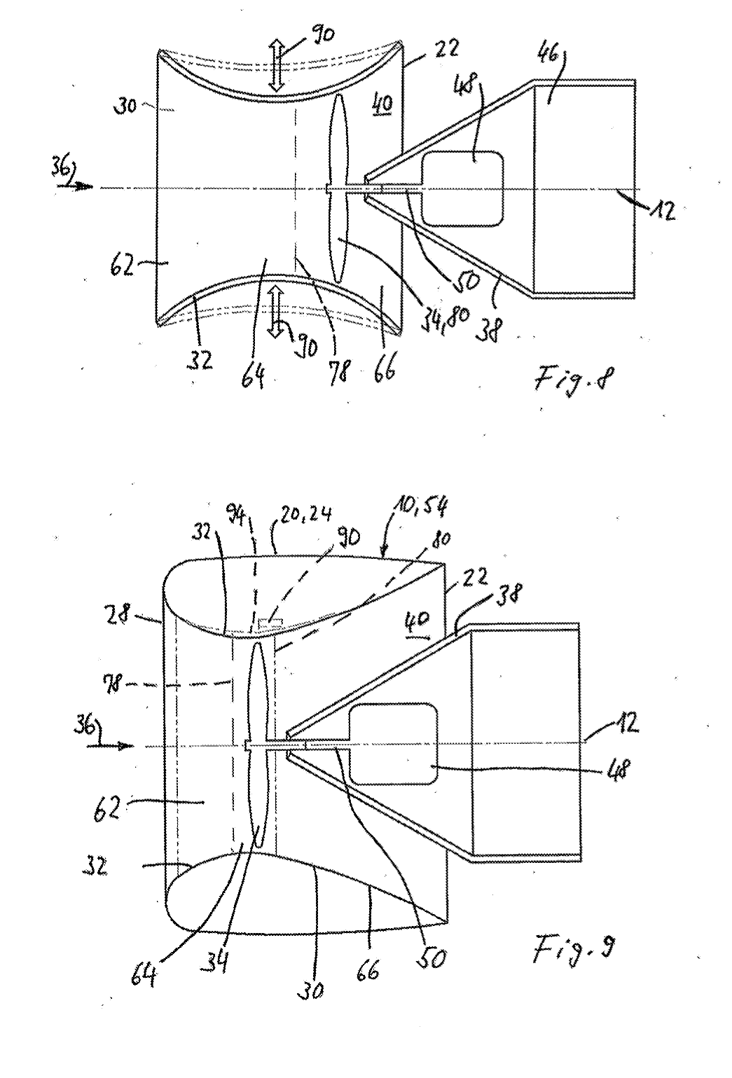

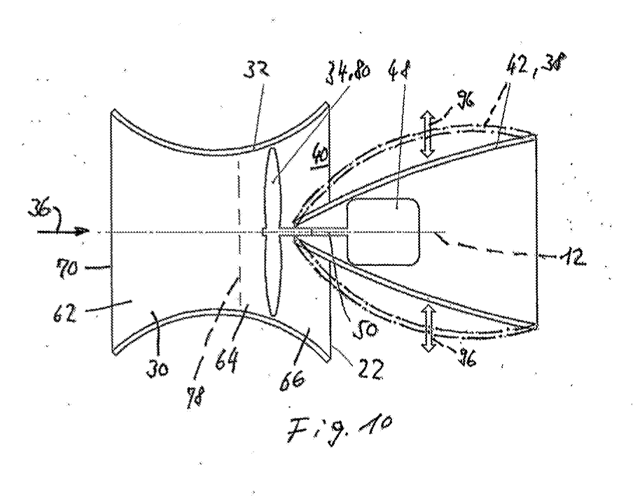

FIG. 7 shows an identical illustration to FIGS. 3 to 60 of one embodiment of the wind power installation, in which the cross section of a center section of the duct wall is of variable configuration,

FIG. 8 shows an identical illustration to FIGS. 3 to 7 of one embodiment of the wind power installation, with a duct wall of diaphragm-like configuration, the cross section of which is of variable configuration.

FIG. 9 shows an identical illustration to FIGS. 3 to 8 of one embodiment of the wind power installation, in which a part of the housing and the duct wall together have the shape of a wing profile, and

FIG. 10 shows an identical illustration to FIGS. 3 to 9 of one embodiment of the wind power installation with a duct wall of diaphragm-like configuration and an inner wall which widens in the flow direction, lies radially on the inside with regard to the duct wall, is of deferrable configuration and can be bent toward the outside.

FIGS. 1 and 2 show a wind power installation with a housing 10 which defines a longitudinal axis 12 and is of droplet-shaped configuration as viewed in the horizontal longitudinal section, as is illustrated by way of the lateral dashed lines 14 in FIG. 2.

The housing 10 has a droplet-shaped, planar top wall 16 and a droplet-shaped, planar bottom wall 18 which is parallel to said top wall 16; the longitudinal axis 12 runs centrally between said walls 16, 18.

A housing wall 20 runs from the edge of the top wall 16 to the edge of the bottom wall 18, which housing wall 20 is interrupted in a manner which forms two lateral outlet openings 22 which lie opposite one another. That upstream front part of the housing wall 20 which extends from the one outlet opening 22 to the other is to be called the front section 24. Those parts of the housing wall 20 which extend from the outlet openings 22 to the downstream end of the housing 10 are to be called side sections 26.

In the front section 24, the housing 10 has an upstream, front-side inlet opening 28 which is of circular configuration as viewed in the direction of the longitudinal axis 12. A flow duct 30 which is delimited on the circumferential side by a duct wall 32 runs in the housing 10 from the inlet opening 28 to the two outlet openings 22.

A propeller 34 which has three blades here is arranged in the flow ducts such that it can be rotated about the longitudinal axis 12.

The duct wall 32 is of rotationally symmetrical configuration with respect to the longitudinal axis 12 from the inlet opening 28 as far as downstream of the propeller 34, and there is a gap between the radially outer ends of the propeller 34 and the duct wall 32, which gap is selected to be as small as possible for optimum utilization of fluid which flows through the flow duct 30, in the present case air; the flow direction of the air is indicated by way of an arrow 36 in FIG. 2.

Downstream of the propeller 34, the flow duct 30 is divided by way of an inner wall 38 into two outlet ducts 40, the inner wall 38 having two wall segments 42 in the exemplary embodiment which is shown, which wall segments 42 extend at a right angle with respect to the bottom wall 18 and from the latter to the top wall 16. As viewed in the flow direction 36, the two wall segments run from a rounded front edge 44 symmetrically with respect to the longitudinal axis 12 away from one another as far as the side sections 26, said two wall sections merging continuously by means of a bend into the side sections 26.

An electric generator 48 (see the following figures) is situated in the rear housing part 46 which is enclosed by the top wall 16, the bottom wall 18, the inner wall 38 and the side sections 26, the propeller 34 being seated on the drive shaft 50 of said electric generator 48, which drive shaft 50 penetrates the front edge 44.

A dash-dotted line indicates an axis 52 which runs at a right angle with respect to the longitudinal axis 12 and, in the present case, in the vertical direction, about which axis 52 the housing 10 is preferably mounted so as to be freely rotatable. As a consequence of the axis 52 which is arranged in the upstream front housing part 54 and as a consequence of the droplet shape of the housing 10, said housing 10 aligns itself automatically in the flow direction 36.

In the exemplary embodiment which is shown, the top wall 16 and bottom wall 18 have lateral recesses 36 which extend from downstream ends of the front section 24 and therefore the upstream end of the outlet openings 22 at a right angle with respect to the longitudinal axis 12 as far as the inner wall 38 and then along the inner wall 38 as far as the side sections 26. As a result, a part of the outlet openings is also situated on the top side and on the bottom side. It is to be noted, however, that it is also possible to dispense with said recesses 56.

In FIG. 1, the designation 58 denotes a mast, on which the housing 10 is arranged in a manner which is mounted such that it can be rotated about the axis 52.

It is to be mentioned at this point that a plurality of wind power installations which are shown in FIGS. 1 and 2 can be arranged in a modular manner above one another, so as to bear against one another in pairs. In this case, it is possible for the top wall 16 of the uppermost wind power installation and the bottom wall 18 of the lowermost wind power installation to be of rotationally cylindrical configuration with respect to the relevant longitudinal axes 12.

As indicated using dashed housing edge lines 60, there is also the possibility, in order to save overall length, to not configure the housing 10 as far as the downstream edge, at which the side sections 26 abut one another, but rather to end it at the housing edge lines 60.

It goes without saying that it is possible for the rear wall which already lies downstream as a result to be of planar or curved configuration.

The following figures show horizontal sections at the level of the longitudinal axis 12 through the flow duct 30 and the inner wall 38, the generator 48 and the propeller 34 which is seated on the drive shaft 50 of said generator 48 which penetrates the inner wall 38 also being shown.

The duct wall 32 which is shown merely diagrammatically has an inlet section 62 upstream., which inner section 62 is configured here so as to taper conically in the flow direction. Said inlet section 62 is followed in the flow direction directly by a center section 64 with the smallest cross section of the flow duct 30. This is followed downstream of the center section 64 directly by an outlet section 66 which widens conically in the present case.

The duct wall 32 which is of rotationally symmetrical configuration with respect to the longitudinal axis 12 here is shown in two pieces in FIGS. 3 to 5. A first duct wall part 68 has the inlet section 62 which, with its upstream end, defines an inlet opening 70 of the flow duct 30, and an adjoining circular-cylindrical first shell part 72. The latter is encompassed by a circular-cylindrical second shell part 74 which is adjoined downstream directly by the outlet section 66. The first shell part 72 and the second shell part 74 are joined in the axial direction and are connected fixedly to one another.

The generator 48 with its drive shaft 50 which is central with respect to the longitudinal axis 12 is situated in the rear housing part 46 which is delimited upstream by the inner wall 38.

A spacing adjustment drive 76 is likewise situated in the rear housing part 46, by means of which spacing adjustment drive 76 the axial position of the propeller 34 can be adjusted.

For this purpose, it is possible to arrange the propeller 34 on the drive shaft 50 such that it can be rotated, but can be displaced in the axial direction, and to change the spacing between the fixedly arranged generator 48 and the propeller 34 by means of the spacing adjustment drive 76, by the propeller 34 being displaced on the drive shaft 50. A further possibility consists in configuring the drive shaft 50 so as to be telescopic, and in arranging the propeller 34 on the extendable part of the drive shaft 50 such that it is fixed both in the circumferential direction and in the axial direction.

A further possibility consists in fastening the generator 48 in the housing 10 on a carriage or slide, and in displacing the generator 48, together with the propeller 34 which is arranged fixedly on its drive shaft 50, into the desired position in the axial direction by means of a position adjustment drive 76′.

As indicated by way of the double arrow in FIG. 3, the propeller 34 can be displaced to and fro between a first upstream end position 78 which is indicated using dashed-dotted lines into a downstream second end position 80 which is shown using continuous lines, intermediate positions also being possible.

The first position 78 is situated between the upstream end, as viewed in the flow direction, and the center of the center section 64. The second position 80 is situated at the downstream end of the center section. It can also be situated in the upstream-side end section of the outlet section 66.

In the case of the embodiment which is shown in FIG. 4, the second duct wall part 68′ is arranged in a stationary manner in the housing 10, whereas the first duct wall part 68 can be displaced in the axial direction with regard to the second duct wall part 68′ by means of a length adjustment drive 82. As a result, the length of the flow duct 30 can be changed.

In the case of the shortest length of the flow duct 30, the first shell part 72 and the second shell part 74 have a maximum overlap. In the exemplary embodiment which is shown, the downstream end of the first shell part 72 lies close to the end of the center section 64 on this side.

In the case of the greatest length of the flow duct 30, the first shell part 72 and the second shell part 74 overlap only slightly, as shown by way of dash-dotted lines.

Whereas, in the case of the embodiment which is shown in FIG. 4, the propeller 34 cannot be changed in its axial position during the transition from the center section 64 to the outlet section 66, the embodiment in accordance with FIG. 5 shows a combination of the embodiments in accordance with FIGS. 3 and 4, in the case of which embodiment both the axial position of the propeller 34 and the length of the flow duct 30 can be changed.

At relatively low wind velocities, the length of the flow duct 30 should probably tend to be large and the position of the propeller 34 should probably be selected at the first position 78. At high wind velocities, the length should probably be small and the position of the propeller should possibly be selected at 80.

In the case of the embodiment in accordance with FIG. 6, the flow duct 30 is delimited by way of the inlet section 62 which tapers conically in the flow direction 36, the center section 64 which adjoins said inlet section 62 with a constant circular cross section, and the outlet section 66 which adjoins said center section 64 and widens conically. Whereas the center section 64 and the outlet section 66 are of unchangeable configuration, the cone angle α of the inlet section 62 can be changed.

For this purpose, the duct wall 32 can be formed in the inlet section 64 from inlet segments 84 which overlap in a scale-like manner in the circumferential direction and, at their downstream end, are mounted on the center section such that they can be pivoted about tangentially running axes.

86 indicates an inlet adjustment drive, by means of which the inlet section 62 can be changed to and fro between a minimum position 88 (indicated using dashed-dotted lines) via the intermediate positions (indicated using continuous lines) into a maximum position 88′ (likewise indicated using dashed-dotted lines). The inlet opening 70 of the flow duct 30 is changed accordingly.

In the case of the embodiment which is shown in FIG. 6, the generator 48 and the propeller 34 are arranged in a stationary manner as viewed in the axial direction, the propeller 34 being situated at the downstream end of the center section 64.

It is also possible in the case of said embodiment, however, for the position of the propeller 34 to be of variable configuration, as shown and described using FIG. 3.

In the case of the embodiment, which is shown in FIG. 7, the conically configured inlet section 62 is adjoined directly by the circular-cylindrical center section 64, the diameter of which is configured so as to be variable by means of a cross section adjustment drive 90 (indicated using double arrows). The center section 64 is adjoined directly by the outlet section 66, the diameter of which widens in the flow direction 36.

The center section 64 of the duct wall 32 can be configured, for example, from wall segments 92 which overlap in a scale-like manner in the circumferential direction and the overlap of which decreases in the case of an increase of the diameter of the flow duct 30 and, conversely, increases in the case of a reduction of the cross section of the flow duct 30.

It is possible for those end regions of the inlet section 62 and the outlet section 66 which lie in each case on the outside as viewed in the longitudinal direction to be of dimensionally stable configuration, and for the respective inner regions to be provided with inlet and outlet segments 84′, respectively, which are mounted on the dimensionally stable sections such that they can be pivoted about tangential axes, and overlap in a scale-like manner in the circumferential direction. By way of the ends which face the center section 64, said inlet and outlet segments 84′ can be guided on the wall segments 92 of the center section, with the result that the cone angle which is defined by way of the inlet and outlet segments 84′ decreases in the case of a radial increase of the center section 64, and vice versa.

It is also possible in the case of the embodiment in accordance with FIG. 7, in a manner which is described in the same way as in conjunction with FIG. 3, to adjust the axial position of the propeller 34 between the first position 78 and the second position 80.

Furthermore, it is also possible in the case of the embodiments which are shown in FIGS. 3 to 7 for the inlet and outlet sections 62, 66 which are shown there in conical form to be of convexly curved configuration in the direction of the longitudinal axis 12, the transitions to and from the center section 64 preferably being continuous.

In the case of the embodiment which is shown in FIG. 8, the duct wall 32 is configured so as to be in one piece, and curved convexly toward the inside in the radial direction and rotationally symmetrical with respect to the longitudinal axis 12 over its entire length as viewed in the direction of the longitudinal axis 12. Here, the duct wall 32 and therefore the flow duct 30 which is delimited by it also have an inlet section 62, a center section 64 which adjoins it directly, and an outlet section 66 which adjoins it downstream and leads to the outlet opening 22.

In the inlet section 62, the cross section of the flow duct 30 narrows continuously in the flow direction 36 whereas, in the center section 62, the change is only slight and the smallest flow cross section is situated there. In the outlet section 66, the flow cross section increases continuously again to a more pronounced extent than in the center section 64. The transition from one section to the other is continuous.

The duct wall 32 can be configured from an elastic material in the manner of a diaphragm, the cross section of the flow duct 30 and therefore also the curvature of the duct wall 32 being variable, as indicated by way of the two double arrows 90 which also symbolize a cross section adjustment drive, between a shape (shown by way of continuous lines) with maximum curvatures and a shape (shown by way of dash-dotted lines) with minimum curvatures, and therefore correspondingly a minimum or maximum smallest diameter of the flow duct 30 in the center section 64.

The configuration of the duct wall 32 from composite materials is also possible.

The generator 48 which is situated in the rear housing part 64 and the propeller 34 which is arranged fixedly on the drive shaft 50 of said generator 48 are shown in a non-adjustable manner, the propeller 34 being situated at the downstream-side transition of the center section 64 in the outlet section 66.

In the case of the narrowest flow duct 30, the entire air flow in practice flows axially onto the propeller 34, whereas, in the case of a wider flow duct 30 in comparison with the former, a radially outer shell part of the air flow flows around the propeller 34.

Accordingly, the flow duct 30 is set to a minimum diameter at relatively low air velocities, and is set to a maximum flow cross section in the case of a storm.

Furthermore, it is also conceivable in the case of said embodiment for the position of the propeller 34 to be of variable configuration, as described and shown in conjunction with FIG. 3.

In the case of the embodiment in accordance with FIG. 9, the housing wall 20 in the front section 24 and the duct wall 32 in the longitudinal cross section form a wing profile. Said wing profile is preferably of rotationally symmetrical configuration, annularly with respect to the longitudinal axis 12.

The inlet section 62 which is curved convexly from the inlet opening 28 is adjoined continuously by the center section 64. The latter is likewise curved convexly, but with a smaller curvature than the inlet section 62. As viewed in the flow direction 36, the center section is adjoined continuously and likewise with a convex curvature by the outlet section 66.

As in the case of all the embodiments, the smallest diameter of the flow duct 30 is situated in the center section 64, where there are the greatest velocities of the fluid.

As shown in FIG. 9, the propeller 34 is also situated in the center section 64.

As indicated by way of a dash-dotted line 94, it is possible to change the profile of the duct wall 32 by means of a cross section adjustment drive 90. For this purpose, it is possible for the duct wall 32 to be of diaphragm-like configuration.

Furthermore, it is also possible in the case of said embodiment for the axial position of the propeller 34 to be of variable configuration, as described in conjunction with FIG. 3.

At high wind velocities, the profile of the duct wall 32 is probably selected to be more streamlined than at lower wind velocities.

In the case of the embodiment which is shown in FIG. 10, the duct wall 32 and therefore the flow duct 30 are configured identically to that shown and described in FIG. 8. A configuration as shown in the remaining figures is also possible, however.

In the case of the embodiment in accordance with FIG. 10, however, the inner wall 38 is of variable configuration, and the wall segments 42 of the inner wall 32 can be moved by means of an inner wall drive 96 which is indicated by way of double arrows out of an at least approximately planar shape into an outwardly convexly curved shape, as a result of which the cross section of the outlet duct 40 can be adapted in accordance with changed wind conditions.

This variability of the inner wall 38 can also be applied in the case of all other embodiments.

It is also possible in the case of the embodiment in accordance with FIG. 10 for the axial position of the propeller 34 to be of variable configuration, as described in conjunction with FIG. 3.

It is to be mentioned that the same designations have been used for identical or identically acting parts of all the embodiments, with the result that the relevant parts are specified via the designations in the figures, even if they are not mentioned specifically in the text of the description of the figures.

1. A continuous-flow energy installation, in particular a wind power installation, having a housing (10) which defines a longitudinal axis (12), has an at least approximately droplet-shaped longitudinal section and can be moved in the flow direction (36) of a driving fluid about an axis (52) which runs at least approximately at a right angle with respect to the longitudinal axis (12); an upstream front-side inlet opening (28) of the housing (10); and an outlet opening (22) of the housing (10), which outlet opening (22) is arranged downstream with respect to said inlet opening (28), having a flow duct (30) for the fluid, which flow duct (30) runs from the inlet opening (28) to the outlet opening (22) in the interior of the housing (10) and is delimited by a duct wall (32); and a propeller (34) for driving an electric generator (48), which propeller (34) is arranged in the flow duct (30), can be rotated about the longitudinal axis (12), and onto which the fluid flows axially; characterized in that the axial position (72, 74) of the propeller (34) is of adjustable configuration and/or the duct wall (32) is of adjustable configuration, in order to optimize the power generation in the case of different fluid conditions, and in that there is a drive (76, 76′, 82, 86, 90, 96) for said adjustment.

2. The continuous-flow energy installation as claimed in claim 1, characterized in that the duct wall (32) has an inlet section (62) which tapers in the flow direction (36) and is preferably rotationally symmetrical with respect to the longitudinal axis (12), a center section (64) which adjoins said inlet section (62) continuously, is rotationally symmetrical with respect to the longitudinal axis (12) and has the smallest diameter of the flow duct (30), and an outlet section (66) which adjoins said center section (64) continuously, leads to the outlet opening (22) and preferably widens in the flow direction (36), and the propeller (34) is arranged in the center section (64) or in an upstream end region of the outlet section (66).

3. The continuous-flow energy installation as claimed in claim 2, characterized in that the length of the center section (64) is of variable configuration, and there is a length adjustment drive (82) for changing the length.

4. The continuous-flow energy installation as claimed in claim 3, characterized in that the center section (64) has a circular-cylindrical cross section and is of telescoping configuration.

5. The continuous-flow energy installation as claimed in claim 2, characterized in that the cross section of the center section (64) is of variable configuration, and there is a cross section adjustment drive (90) for changing the cross section.

6. The continuous-flow energy installation as claimed in claim 5, characterized in that the center section (64) is of diaphragm-like configuration.

7. The continuous-flow energy installation as claimed in claim 2, characterized in that the inlet section (62) defines an upstream inlet opening (70) and is of variable configuration such that the inlet opening (70) can be made larger and smaller, and in that there is an inlet adjustment drive (86) for changing the inlet section (62).

8. The continuous-flow energy installation as claimed in claim 7, characterized in that the inlet section (62) has inlet segments (84) which overlap in a scale-like manner in the circumferential direction.

9. The continuous-flow energy installation as claimed in claim 2, characterized in that, furthermore, the flow duct (30) is delimited in the outlet section (66) by way of an inner wall (38) which widens in the flow direction (30) and lies on the inside with regard to the duct wall (32).

10. The continuous-flow energy installation as claimed in claim 8, characterized in that the inner wall (38) is of deformable configuration, and there is an inner wall drive (96) for changing the shape of the inner wall (38).

11. The continuous-flow energy installation as claimed in claim 2, characterized in that the generator (48) which is operatively connected to the propeller (34) is arranged in the housing (10) downstream of the inner wall (38).

12. The continuous-flow energy installation as claimed in claim 11, characterized in that the generator (48) and the propeller (34) are arranged at a fixed spacing from one another and are mounted such that they can be adjusted together with regard to the housing (10) in the direction of the longitudinal axis (12), and there is a position adjustment drive (76′) for changing the axial position of the generator (48) and the propeller (34).

13. The continuous-flow energy installation as claimed in claim 11, characterized in that the generator (48) is arranged in a stationary manner with regard to the housing (10), and the axially measured spacing between the propeller (34) and the generator (48) is of variable configuration, and there is a spacing adjustment drive (76) for changing the spacing between the generator (48) and the propeller (34).

14. The continuous-flow energy installation as claimed in claim 1, characterized by a single inlet opening (28) and two lateral outlet openings (22) which lie opposite one another.

15. The continuous-flow energy installation as claimed in claim 1, characterized by a mast (58), on which the housing (10) is mounted such that it can be pivoted about the axis (52).

16. The continuous-flow energy installation as claimed in claim 4, wherein the cross section of the center section is of variable configuration, and there is a cross section adjustment drive for changing the cross section.

17. The continuous-flow energy installation as claimed in claim 4, wherein the inlet section defines an upstream inlet opening and is of variable configuration such that the inlet opening can be made larger and smaller, and in that there is an inlet adjustment drive for changing the inlet section.

18. The continuous-flow energy installation as claimed in claim 5, wherein the inlet section defines an upstream inlet opening and is of variable configuration such that the inlet opening can be made larger and smaller, and in that there is an inlet adjustment drive for changing the inlet section.

19. The continuous-flow energy installation as claimed in claim 5, wherein the flow duct is delimited in the outlet section by way of an inner wall which widens in the flow direction and lies on the inside with regard to the duct wall.

20. The continuous-flow energy installation as claimed in claim 8, wherein the flow duct is delimited in the outlet section by way of an inner wall which widens in the flow direction and lies on the inside with regard to the duct wall.
